(19) United States
(12) Patent Application Publication
(10) Pub. No.: US 2008/0183759 A1
(43) Pub. Date: Jul. 31, 2008

(54) SYSTEM AND METHOD FOR MATCHING EXPERTISE

(75) Inventor: Peter J. Dehlinger, Palo Alto, CA (US)

Correspondence Address: PERKINS COIE LLP, P.O. BOX 2168, MENLO PARK, CA, 94026, US

(73) Assignee: WORD DATA CORP, Palo Alto, CA (US)

(21) Appl. No.: 12/021,063

(22) Filed: Jan. 28, 2008

Related U.S. Application Data
(60) Provisional application No. 60/898,322, filed on Jan. 29, 2007.

(51) Int. Cl. G06F 17/30

(52) U.S. Cl. 707/104.1; 707/E17.044

(57) ABSTRACT

Disclosed are a method, machine-readable code, and a database for use in identifying, among a group of patent practitioners, one or more practitioners having expertise related to a given invention or technology. In the method, a search query related to the given invention or technology is used to identify one or more texts of patent abstracts or claims or patent class definitions having high term matches with the user-input query. The identified text(s) are linked to patent-class tags associated with the texts, and the identified tags are linked to one or more members of a group of patent practitioners who wrote and/or prosecuted patents having the patent-class assignments.

This patent application claims priority to U.S. Provisional Patent Application No. 60/898,322 filed on Jan. 29, 2007, which is incorporated herein in its entirety by reference.

### FIELD OF THE INVENTION

The present invention relates to a method and machine readable code for identifying patent practitioners having expertise related to a given invention or technical area.

### BACKGROUND OF THE INVENTION

The internet has made it easier for inventors or corporate legal departments to identify patent practitioners, i.e., patent agents and attorneys, who have the technical qualifications to prosecute their inventions. For example, an inventor or in-house legal department seeking patent representation on a new invention can search law-firm websites for patent specialists in the legal area of interest, then further navigate within a selected website to identify individual practitioners who may be most experienced in that area of technology.

These internet search tools augment the more traditional ways of locating competent patent practitioners, such as referrals from friends or colleagues, or yellow-page listings. However, like the more traditional means, they tend to be somewhat random, in that there is rarely a good filter for discriminating among scores or hundreds of practitioners in a given locale. Also like the more traditional methods, they may have a strong marketing bias, in that web postings may be more promotional than informative.

There is thus a need for a website tool that offers inventors or other patent clients a more direct and reliable method for identifying patent practitioners with expertise related to a given invention or technology.

### SUMMARY OF THE INVENTION

The invention includes, in one aspect, a computer-assisted method for identifying, from among a group of patent practitioners in a specified locale, one or more practitioners having technical expertise related to a given invention or area of technology. The method comprises the steps of:

(a) processing a user-input query composed of word, and optionally, word-group terms that are descriptive of the given invention or area of technology,

(b) accessing a database containing a word index of texts of patent abstracts or patent claims or patent classification definitions, to identify one or more texts having high term matches with the user-input query,

(c) accessing a database containing texts linked to patent-class tags associated with those texts, to identify one or more one or more patent-class tags linked to the texts identified in step (b),

(d) accessing a database containing patent-class tags linked to the names and locales of patent practitioners who have prepared patents to which such patent-class tags have been assigned, to identify one or more patent practitioners in a given locale associated with the patent-class tags identified in step (c) and

(e) presenting the patent practitioners identified in step (d) to the user.

The processing in step (a) may include constructing a search vector composed of non-generic words, and optionally, word-group terms, and term-value coefficients assigned to each term, and accessing step (b) may be effective to identify texts having the top match score with the search vector.

The database accessed in each of steps (b)-(d) may be part of a single relational database. The database accessed in step (b) may include a word index of abstracts from patents, and the database accessed in step (c) may include a text-ID table linking the patent abstracts to patent-class number tags associated with patents from which the abstracts are taken. The database accessed in step (b) may include a word index of patent-class definitions, and the database accessed in step (c) may include a text-ID table linking the patent-class definitions to associated patent-class number tags.

The database accessed in step (c) may include a matrix whose matrix values represent, for each pair of patent-class tags, a co-occurrence value related to the document co-occurrence of the two tags of the pair in the patents from which the tags were taken, and step (c) may include accessing the database to identify one or more one or more tags linked directly to the text(s) identified in step (b), or linked indirectly to the text(s) identified in (b) through an above-threshold co-occurrence value to a tag directly linked to such text(s). The user may adjust the co-occurrence value applied by the method in step (d).

The database accessed in step (d) may include a locale database in which specified locales are zip codes or counties or their equivalents that are linked to proximate zip codes or counties, and step (d) includes accessing this database to identify one or more patent practitioners linked to a specified locale or linked to locale that is proximate to the specific locale. The user may adjust the degree of locale proximity applied by the method in step (d).

The patent practitioner names presented to the user may include, for each name, a link to that patent practitioner's website.

In another aspect the invention includes, for use in identifying, among a group of patent practitioners in a given locale, one or more practitioners having technical expertise related to a given invention or technology, machine-readable code which is operable on a computer to execute machine-readable instructions for performing the above method steps. The databases accessed in the method may be database tables in a relational database.

Also disclosed is a relational database for use in identifying, among a group of patent practitioners, one or more practitioners having expertise related to a given invention or technology. The database includes:

(i) a word index of texts of patent abstracts or claims or patent-class definitions taken from a library of patents or from a dictionary of patent class definitions, respectively,

(ii) a table of patent-class tags linked to the texts, where the tags represent patent-class tags assigned to said texts, and

(iii) a table of group-member identifiers linked to patent-class tags, through patent-class tags taken from patents prepared by members of the group of practitioners.

The database may also include a matrix whose matrix values represent, for each pair of patent-class tags, a co-occurrence value related to the document co-occurrence of the two tags of the pair in the patents from which the tags were taken.

These and other objects and features of the invention will become more fully apparent when the following detailed description of the invention is read in conjunction with the accompanying drawings.

### BRIEF DESCRIPTION OF THE DRAWINGS

FIG. 1 shows hardware and database components of the system of the invention;

FIG. 2A shows, in summary diagram form, the processing of patents to form a class-ID patent table, a class co-occurrence table, a patent abstract text-ID table, and a word index of abstracts in an embodiment of the invention;

FIG. 2B shows in summary diagram form, the processing of group-authored patents to form a class-ID group table, in an embodiment of the invention;

FIGS. 3A-3F show representative table entries in a patent-abstract text-ID table (3A), a class-definition text-ID table (3B), a word index of texts (3C), a class-ID table (3D), a class-ID group table (3E), and a locale-proximity table (3F);

FIG. 4 shows a portion of a class-tag co-occurrence table;

FIG. 5 shows in flow diagram form, operations in processing of a library of patents to form an abstract text-ID table;

FIG. 6 shows in flow diagram form, operations in processing a library of patents to form an a class-ID patent table;

FIG. 7 is a flow diagram of steps used in forming a word-index table of patent texts;

FIG. 8 is a flow diagram of steps used in generating a co-occurrence matrix;

FIG. 9 is a flow diagram shows steps in the construction of a class-ID group table;

FIG. 10 shows a user interface for the method of the invention;

FIG. 11 is a flow diagram of steps used in identifying top-ranked texts and patent-class tags for a given user-input query in an embodiment of the invention; and

FIG. 12 is a flow diagram of steps for retrieving and displaying group names to the user.

### DETAILED DESCRIPTION OF THE INVENTION

### A. Definitions

A “search query” or “query statement” or “user-input query” refers to a single sentence or sentence fragment or fragments or list of words and/or word groups that describe or are descriptive of a given invention or area of technology.

A “verb-root” word is a word or statement that has a verb root. Thus, the word “light” or “lights” (the noun), “light” (the adjective), “lightly” (the adverb) and various forms of “light” (the verb), such as light, lighted, lighting, lit, lights, to light, has been lighted, etc., are all verb-root words with the same verb root form “light,” where the verb root form selected is typically the present-tense singular (infinitive) form of the verb.

“Generic words” refers to words in a natural-language passage that are not descriptive of, or only non-specifically descriptive of, the subject matter of the passage. Examples include prepositions, conjunctions, pronouns, as well as certain nouns, verbs, adverbs, and adjectives that occur frequently in passages from patent texts. “Non-generic words” are those words in a passage remaining after generic words are removed.

“Patent documents” refer to issued or granted patents and published or otherwise publicly available patent applications.

A “document identifier” or “DID” identifies a particular patent document, typically by patent or application number.

A “text identifier” or “TID” identifies a particular patent-related text, which may include a patent summary or abstract, one or more patent claims, or a patent-classification definition.

A “class identifier” or “CID” identifies a particular patent classification number, typically, in the U.S. patent classification system, a patent class/subclass pair, e.g., 260/145, referring to U.S. patent class 200, subclass 145.

A “database” refers to a database of records or tables containing information about documents and/or other document- or citation-related information. A database typically includes two or more tables, each containing locators by which information in one table can be used to access information in another table or tables.

“Locale” refers to geographical area, and may be identified, for example, by county name or zip code number.

A “group member” refers to a member of a group of patent practitioners, e.g., patent attorneys and agents, whose patent qualifications are accessible to users in the method of the invention.

### B. System Components

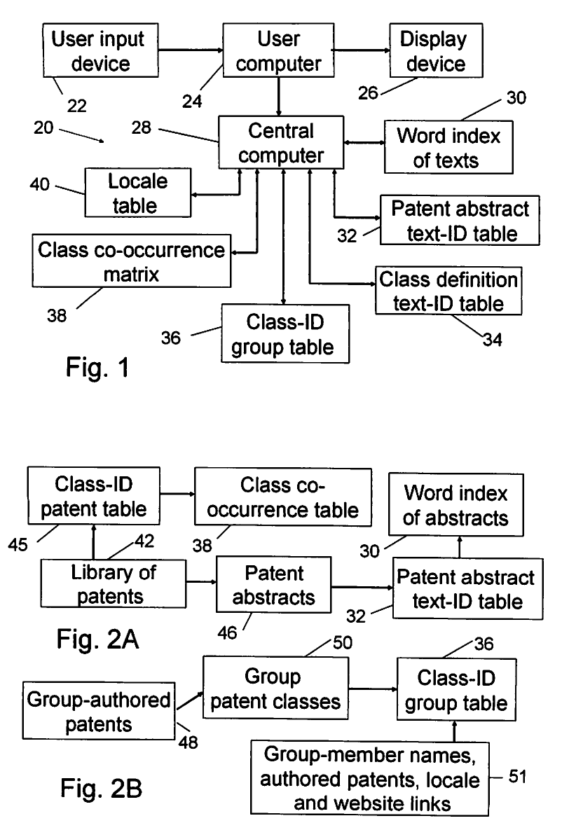

FIG. 1 shows the basic components of a system 20 for use in identifying, among a group of patent professionals, one or more professionals having expertise with a given invention or technology.

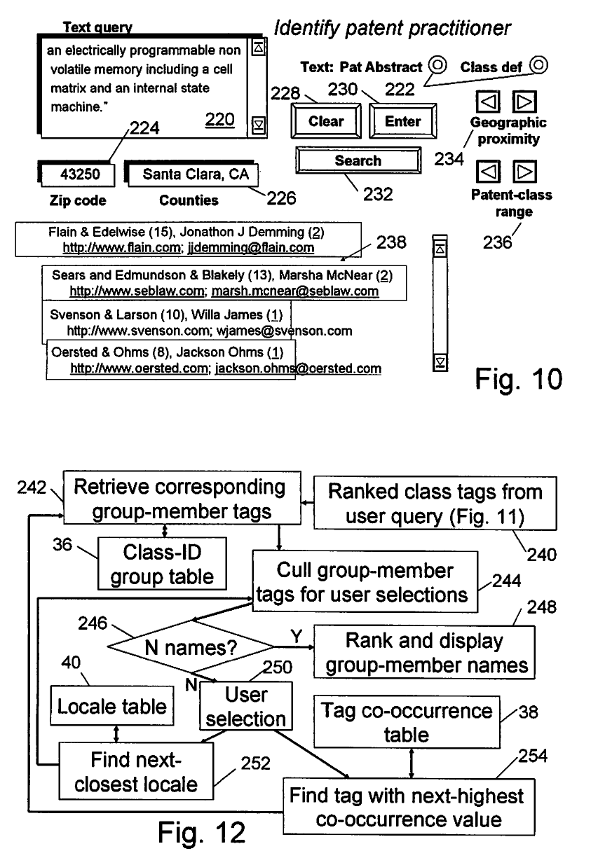

A computer or processor 24 in the system may be a personal computer or a central computer or server that communicates with a user's personal computer. The computer has an input device 22, such as a keyboard, by which the user can enter a query or other information, as will be described below. A display or monitor 26 displays the interface and program operation states and output. One exemplary interface is described below with respect to FIG. 10. Computer 24 in the system is typically one of many user terminal computers, each of which communicates with a central server or processor 28 on which the main program activity in the system takes place.

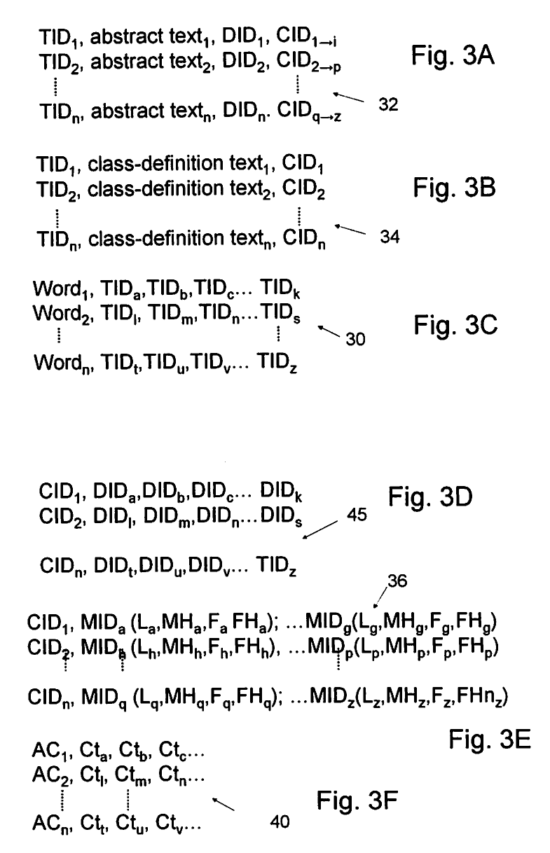

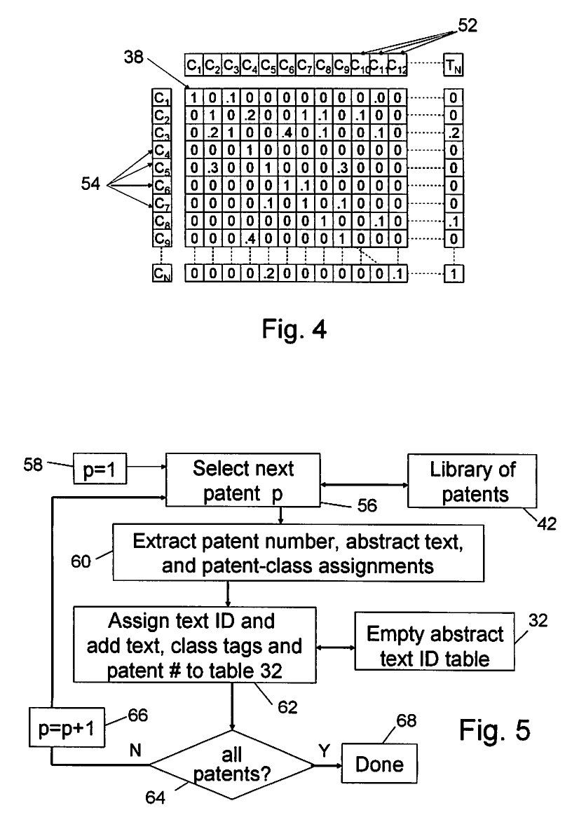

A database in the system, typically run on processor or server 28, includes in one embodiment a word-index of texts table 30, a patent abstract text-ID table 32, a patent class definition text-ID table 34, a class-ID group table 36, and a locale table 40, all of which will be described below, e.g., with reference to FIGS. 3A-3F. The database may also include a co-occurrence matrix 38 described below with reference to FIG. 4 and FIG. 8. The database also includes a tool that operates on the server to access and act on information contained in the database tables, in accordance with the program steps described below. One exemplary database tool is MySQL database tool, which can be accessed at www.mysql.com.

It will be appreciated that the assignment of various stored documents, databases, database tools and search modules, to be detailed below, to a user computer or a central server or central processing station is made on the basis of computer storage capacity and speed of operations, but may be modified without altering the basic functions and operations to be described.

### C. Basic Database Tables and Data Relationships

FIG. 2A is a flow diagram of the high-level steps used in processing a library of patent documents 42 to produce database tables that link patent-class numbers or identifiers (CIDs) to patent-document numbers or identifiers (DIDs) and to patent-text identifiers (TIDs) that identify patent abstracts or claims extracted from patent documents.

The patent library in FIG. 2A may include all patents and applications from one or more patent forums; for example, where the method is used in finding U.S. patent practitioners, all U.S. patents that are accessible in electronic form, e.g., U.S. patents that issued between 1976 and the present.

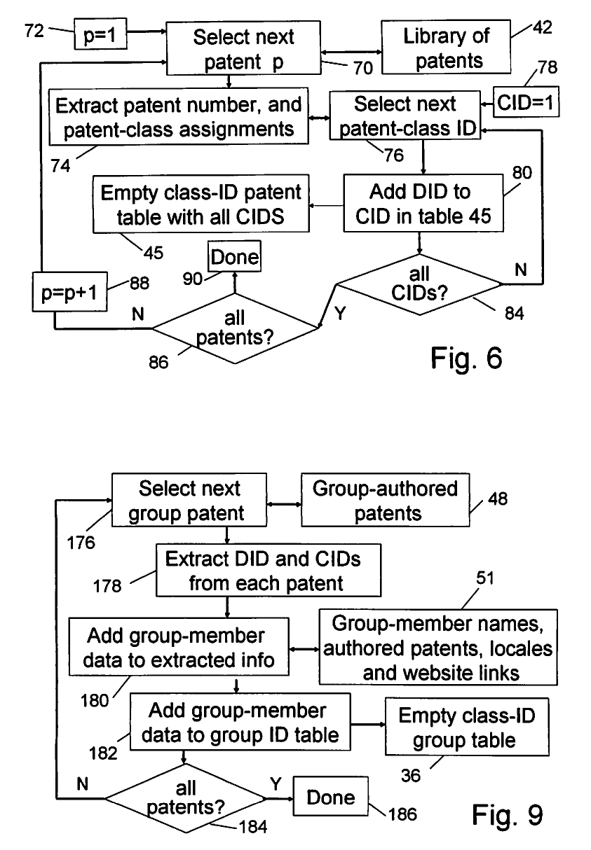

The program described in FIGS. 5 and 6 operates to extract, from each patent, the patent issue number or application number, a patent text, such as the patent abstract and/or one or more of the patent claims, and the patent-classification numbers that have been assigned to a patent, For U.S. patents, the patent classification numbers typically include both the patent-class number assigned to the patent, indicated as “current U.S. class”, and all patent classes that are indicated as being searched during patent examination, indicated by “field or search”: This information is contained in well-defined fields in digitized patent files, and can be easily identified and extracted from the patent files.

In one embodiment, the patent text that is extracted from the patents is the patent abstracts, indicated at 46 in FIG. 2A, which along with the associated patent number (DID) and assigned patent classes (CIDs), is assembled into a patent-abstract text-ID table 32 whose table entries are shown in FIG. 3A. Details of the processing of patents to form table 32 are given below with respect to FIG. 5. In another embodiment, the patent text that is extracted from the patent documents is a main independent claim, e.g., claim 1 of the patent.

Table 34 seen in FIG. 3B has similar entries, except that the patent texts in this table are patent classification definitions associated with a patent-class identifier (TID) which may be an arbitrary identification number or the actual class number (CID). Dictionaries of patent-class definitions are available, for example, from national patent-office websites, for example, in the case of the USPTO website, through the website URL http://www.uspto.gov/web/patents/classification/index.htm. The dictionaries can be easily processed for patent classification definitions.

Also as shown in FIG. 2A, patent texts, e.g., abstracts, in Table 32 are processed to produce a word-index of abstracts table 30, whose table entries are shown in FIG. 3C. The key locator for the word-index table is a text word, such as Words shown in FIG. 3C, and for each word, there is a list of all TIDs containing that word. Preferably, the words in the table do not include generic words, such as common pronouns, conjunctions, prepositions, etc., and may also exclude as certain generic words that are common to a large number of patent texts, such as “device,” “method,” “element,” “comprise,” “material,” “member” and the like. The patent texts in Table 32 in FIG. 3A or Table 34 in FIG. 3B are processed, in accordance with the method described below with respect to FIG. 7, to form the word index of texts table 30.

Also as shown in FIG. 2A the library of patents are processed to form class-ID patent table 45, as will be described below with respect to FIG. 6. Table entries in table 45 are illustrated in FIG. 3D, and include, for each table row, a CID as a table locator, and a list of all patent DIDs that have been assigned that patent class CID. Table 45, in turn, is used in creating class co-occurrence matrix 38. The co-occurrence matrix, a portion of which is shown below in FIG. 4, is an N×N matrix of N row class tags 52, such as Cᵢ, Cⱼ, and Cₖ, and N column class tags 54, such as tags C₁, C₂, C₃, and C_{w}, where the value of each matrix entry for a CᵢCⱼ matrix pair is the number of times the two tags (assigned patent classes) Cᵢ and Cⱼ appear in the same document in the library of processed patents. The sum of the values in each row may be normalized to a common value, e.g., such that the sum of all matrix values in a given row is 1. The matrix is formed in accordance with the method described with respect to FIG. 8.

The database tables just described form the database of texts and class tags used in the method for associating a user-statement query, representing the given invention or technical area for which expertise is being sought, to one of more class tags, representing an identifiable tag (patent class) identifier associated with the retrieved texts. The database tables now to be described with reference to FIG. 2B are used in connecting these one or more identified class tags to a patent professional experienced in a selected area of invention.

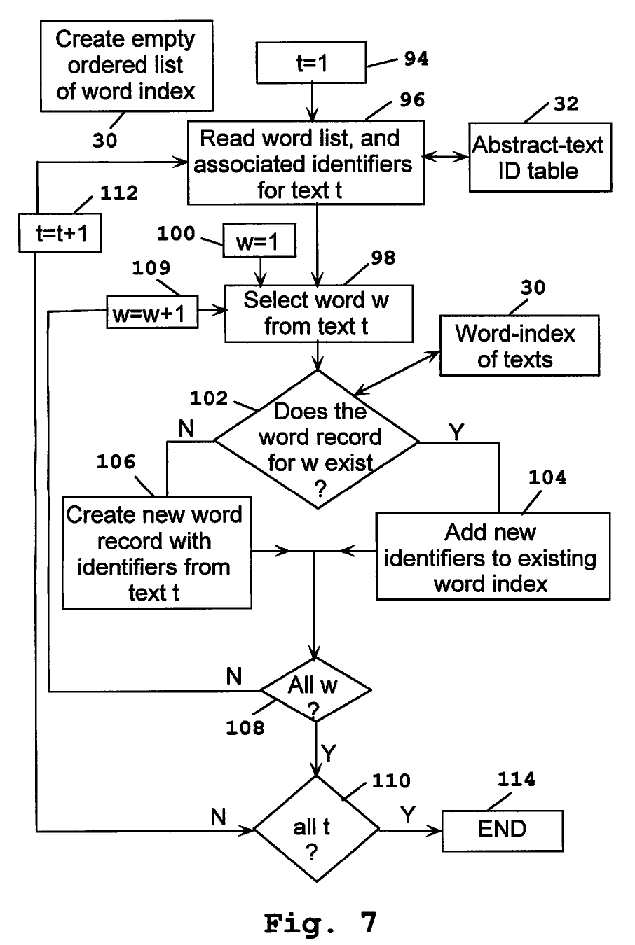

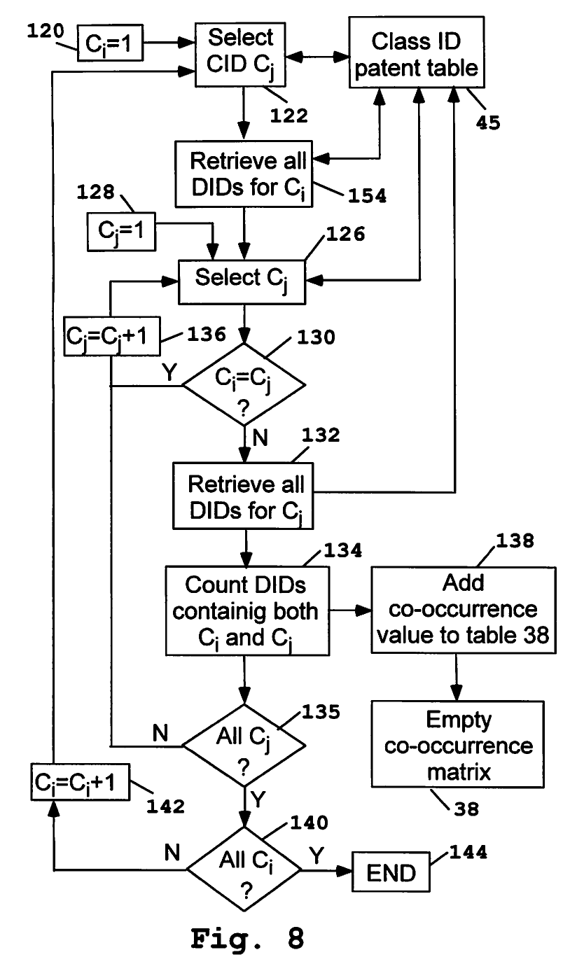

With reference to FIG. 2B, group-ID table shown at 36 is generated from a collection of group-authored patents 48, i.e., patents that have been written or prosecuted by group-member patent practitioners who wish to promote their patent expertise in the fields or technical areas of the patents. The processing steps, described below with respect to FIG. 9, include extracting the patent number and assigned patent class numbers from each patent, to form a table of group patent classes 50 that associate each group member name with one or more patent numbers (DIDs) and the classification numbers (CIDs) associated with the patent. Thus one group member may be associated with multiple DIDs and CIDs.

The information in table 50 is combined with additional group-member information, such as group-member name, authored patents, locales and firm and individual website links, indicated at 51 in FIG. 2B, to form the class-ID group table 36, as will be detailed below with respect to FIG. 9. Representative entries from the table are shown at 36 in FIG. 3E. The locator in the table is an individual class number CID, and for each CID, all of the group-member identifiers (MIDs) who have authored or otherwise contributed to a patent document assigned that CID. As seen, each group-member MIDᵢ associated with a class tag in table 36 contains information about that member's locale or location or primary place of business (Lᵢ), a direct link to the member's website, MHᵢ, the name of the group-member's firm or institution Fᵢ, and link to the member firm's website, FHᵢ. Note that each class tag row in the table contains the identity (MID) and member information of all group members that are associated with a given tag.

Finally, locale table 40 uses an area code (AC) locator to track, for each ACᵢ, the county (or comparable region, such as state, parish, or the like) which includes that area code (Ctₐ), and each of the counties (or regions), Ct_{b}, . . . . Ctₙ, that are most proximate to the area-code county, typically weighted by population, for example the ten most proximate counties, ranked in order of proximity and population. That is, is two counties are both directly adjacent to the Ctₐ, the county with the larger population is ranked first, and if two counties are separated from CTₐ by one or more counties, only those counties with a threshold population are considered. This will allow the user to approximate a “metropolitan area” through the designation of a single local area code.

### D. Processing Patent Documents and Constructing the Word-Index and Co-Occurrence Tables

FIG. 5 is a flow diagram of steps employed by the system in extracting pertinent table information from each of a plurality of the patents in patent library 42. With the patent counter 58 set to 1, the program selects the first patent in the library, at 56, and extracts from the patent, the patent number, e.g., issued patent number or published application number, one or more patent texts, e.g., the patent abstract and/or a main claim, and the patent-class assignment, i.e., the patent classes appearing on the front page of the patent, all as indicated at 60 in the figures. Each patent text is now assigned a text ID (TID) and placed as a new row entry in empty table 32, along with the associated patent text and DID and CIDs. This processing is repeated for each patent in the library, through the logic of 64, 66, until all of the patents have been processed and table 32 is complete. It is noted that the table can be readily updated, as new patent documents become available, simply by adding new rows to the table.

The library of patent documents, or the extracted patent data at 60 in FIG. 5, may be processed to form class-ID patent table shown at 45 in FIGS. 2A and 3D. In FIG. 6, which illustrates the method applied processing library of patents 42, a patent counter p is set to 1 (box 72) and patent p is selected, at 70, from library 42. The program processes the patent to extract patent number (DID) and assigned patent-classes (CIDs), as shown at 74. Alternatively, the program may use the patent data already extracted at 60 in the processing steps described with respect to FIG. 5.

With the CID counter set to 1, at 78, the program selects the first or next patent-class ID (CID), at 76 and adds the DID for that patent to the appropriate table row CID in the empty class-ID patent table 45 in the figure, at 80. That is, the table includes a list of all possible CIDs (e.g., all patent class and subclass numbers), and the program acts to fill each locator CID row with the patents that have been assigned to the CID. This is done through the logic of 84, which adds the selected p DID to each of the assigned CIDs in table 45, and through the logic of 86 and 88, which successively processes each of the library patents in the above fashion.

As noted above, the program uses non-generic words contained in the texts stored in the text-ID table 32 or 34 to generate a word-index of texts table 30. This table is essentially a dictionary of all non-generic words found in the applicable patent texts, e.g., patent abstracts or claims (table 32) or patent-class definitions (table 34), where each word is a table locator, and each word row contains TIDs for all texts containing that word.

To form the word-records or word index of texts table, and with reference to FIG. 7, the program creates an empty ordered list 30, and initializes the TID to t=1, at 94. The program now retrieves TID₁ from the text-ID table 32 (or 34), and stores a list of non-generic words in the text, and also reads in the associated identifiers for that text, at 96. With the word number initialized at 1, at 100, the program selects the first word w in text t, at 98, and asks, at 102, is word w already in the word index table. If it is, the word record identifiers (associated TID and optionally, DID) for word w are added to word-index table 30 for that word in the table, at 104. If not, a new word entry is created in table 30, at 106, along with the associated TID identifiers. This process is repeated, through the logic of 108, 109, until all of the non-generic words in text t have been added to the table. Once a statement has been processed, the program advances, through the logic of 110, 112, until all texts in text table 32 have been processed and added to the word-index table, terminating the processing steps at 142.

In one exemplary embodiment, every verb-root word in a statement is converted to its verb root; that is, all verb-root variants of a verb-root word are converted to a common verb-root word.

The system also may include one or more “class-tag affinity” matrices used in various system operations to be described below. As used herein, “class-tag affinity matrix” refers to an N×N matrix of N class tags, where each matrix value tag i×tag j indicates the affinity of tags (patent classes) i and j in the patent documents from which the N class tags are extracted. This section considers, as an exemplary affinity matrix, co-occurrence matrix 38 whose matrix values are the normalized number of document co-occurrences of each pair of class tags in patent-document abstracts, as described above with respect to FIG. 4.

FIG. 8 is a flow diagram of steps employed in the system for generating co-occurrence matrix 38. As noted above, this is an N×N matrix of all N tags, where each i×j term in the matrix is the number occurrence of all patent documents in the system that contain both class tags CIDᵢ and CIDⱼ, where the matrix values may be normalized to 1, that is, the matrix values may be adjusted so that the sum of all of the matrix values for a given class tags in a matrix row is one. To construct the matrix, Cᵢ is initialized to i=1, at 120, and the program selects at 122, tag C₁ from the class-ID patent table 45, and retrieves all of the DIDs for that CID, at 124. A second class-tag count at 128 is set at j=1 for class tags Cⱼ, and a second tag Cⱼ is selected from table 45, as at 126. If Cⱼ is the same as Cᵢ, the program advances to the next Cⱼ, through the logic of 130, 136, and a zero is placed at the Cᵢ×Cᵢ matrix position (on the matrix diagonal). If Cᵢ and Cⱼ are different class tags, the program retrieves all DIDs for Cⱼ, at 132, from class-ID table 45, and then counts the number of documents (common DIDs) that contain both Cᵢ and Cⱼ (box 134). This “co-occurrence” value is added, at 138, to empty co-occurrence matrix 38.

This process is repeated, through the logic of 135, 136, until all Cᵢ×Cⱼ co-occurrence values have been determined for the selected tag Cᵢ. The program then advances to the next class tag Cᵢ₊₁, through the logic of 140, 142, until the matrix values for all N class tags have been determined, at 174. The matrix values for each matrix row may now be normalized to a sum of 1, as indicated above. The program terminates at 144.

### E. Generating the Class-ID Group Table

FIG. 9 illustrates, in flow-diagram form, steps in generating a class-ID group table 36 whose table entries are discussed above with respect to FIG. 3E. The group patent documents used in constructing the table, and indicated at 48 in the figure, are patent documents authored (written and/or prosecuted) by members of the one or more of the patent professionals who constitute the target patent professionals of the search in the system.

Initially the program selects at 176 a first group-authored patent document from the documents 48, and this document is processed at 178 essentially as described above with respect to FIG. 6, to extract the patent number and all assigned patent classes (CIDs) as in the processing used in FIG. 6. For each patent, table 50 is accessed at 180 to retrieve, for that patent, the name or names of authoring group-members, their locale(s) and website links, and this information is added to each associated CID locator in empty class-ID table 36 which includes a list of all possible CIDs with rows to be filled with group-member data. Thus, for each group-member patent, the program adds to each CID in table 36 the group member data for each CID assigned to that patent, at 182. This processing is repeated, through the logic of 184, until all group-authored patents have been processed, and the program then terminates at 186. It will be appreciated that additional group-authored patents, or additional group members, or changes in group-member information can be added easily to the existing table as the new information becomes available.

### F. User interface

FIG. 10 shows a graphical interface in the system of the invention. The interface provides a text box 220 for entering a description of the invention or technical field for which a patent expert is being sought. Radio buttons 222 are for the user to indicate whether the text being entered will be used to search patent abstracts (or claims) texts or patent-class definition texts. Button 228 in the interface will clear any existing query text in box 220, and button 230 will enter the words of the text in the box, creating a word search vector for the search. The search is initiated by clicking button 232, and the search results given in the lower half of the interface at 238 are scrollable through the located group-member names. As seen, each group-member entry includes the firm name, along with the number of total class tags found for that firm in parenthesis, individual group name, and number of class tags found for that individual, the website links to both the firm and individual. Thus the user, by clicking on one of these links, navigates directly to the firm's or individual's website, for further determining the qualifications of the firm and/or individual.

The user will typically limit the search to practitioners in a given locale by entering a “home” zip code at 224, and this in turn will show the corresponding county (or other identified region) in box 226. To expand the geographic range of the search, the user can click on right-arrow button at 234, which will include additional counties in the search by (i) consulting locale table 40, (ii) finding the next rank county, and (iii) adding this county to the search, where each click of the right-arrow button will add the next ranked county, in accordance with the order of counties in the locale table, and each click on the left-arrow button will remove a county. Similarly, if the search shows too few names, the user can expand the patent-class range of the search, as described below with reference to FIG. 12, by clicking on the right-arrow button at 236, and similarly, can limit the patent-class range, by clicking on the left-arrow button at 236.

### G. Statement Searching for Professional Expertise

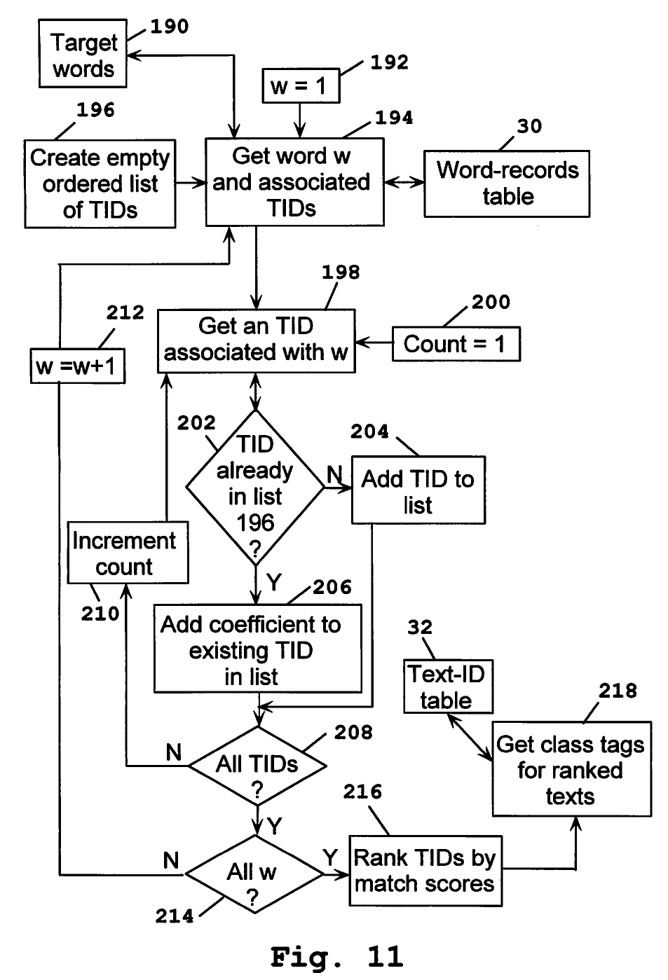

This section considers, with reference to FIGS. 11 and 12, the operation of the system in finding one or more patent-related texts and patent-class tags in response to a user input query composed of word, and optionally, word-group terms that describe or are descriptive of the given invention or technical field for which patent expertise is being sought. As will be appreciated from the search procedures described below, the input query represents a content-rich shorthand to the subject matter, providing a high-content “hook” to a patent-related text. Once a group of ranked texts is returned in the search, the program identifies associated patent-class tags and links these tags to group-member professionals.

Invention-related texts are identified and selected, in accordance with one embodiment of the invention, by the user entering a word query that represents or is representative of the invention or technical area of interest. The system then searches the designated patent-abstract or patent-class definition texts, and returns texts that have the closest (highest-ranking) word match with that query, along with pertinent patent-class tags associated with the texts. As a first step in the search, the program converts the user query, which can include either a user-input statement or group of word, into a search vector. The search vector may be composed of word and optionally word-pair terms, and for each term, a coefficient that indicates the weight that term is to be given, relative to other terms in the vector. In one embodiment, the vector terms are simply all of the non-generic words contained in the user query, with each word being assigned a coefficient value of 1. In this embodiment, the program simply reads the paragraph summary, extracts non-generic words, converts verb words to verb-root words, and assigns each term a coefficient of 1. If a more refined search is desired, the program may operate to extract both non-generic words and, optionally, proximately formed word pairs in constructing the search vector, and assign to these terms either the same coefficient, e.g., 1, or a coefficient related to the term's selectivity value and optionally, inverse document frequency (IDF) (in the case of word terms), as described, for example, in co-owned U.S. Pat. No. 7,024,408 for Text-Classification Code, System, and Method, and U.S. Pat. No. 7,016,895, for Text-Classification System and Method, both of which are incorporated herein by reference in its entirety. These patents also illustrate how patent abstract text searching can be employed to identify patent classes associated with the patents. In particular, FIGS. 19-21 of the '408 patent show patent classification efficiencies with various search parameters related to root functions, the presence or absence of word pairs, and various combinations of selectivity value and inverse document frequency value coefficients, as applied to six different technical fields.

Although not shown here, the vector may be modified to include synonyms for one or more “base” words in the vector. These synonyms may be drawn, for example, from a dictionary of verb and verb-root synonyms such as discussed above. Here the vector coefficients are unchanged, but one or more of the base word terms may contain multiple words, again as described in the above co-owned U.S. patents.

As indicated above, the search operates to find the texts in the system database having the greatest term overlap with the target search vector terms. Briefly, and with reference to FIG. 11, an empty ordered list of patent-class tags (TIDs), shown at 196, stores the accumulating match-score values for each TID associated with the vector terms. The program initializes the vector term (e.g., word) at w=1 (box 192) and retrieves (box 194) the first word and associated coefficient from target words 190 and retrieves all of the TIDs associated with that word from word index of texts 30. With the TID count set to 1 (box 200), the program gets a TID associated with word w (box 198). With each TID that is considered, the program asks, at 202: Is the TID already present in list 196? If it is not, the TID and the term coefficient for word w are added to list 196, creating the first coefficient of the summed coefficients for that TID. (For the first word of the search vector (w=1), each TID will be newly added to the list.). If the TID is already in list 196, the program adds the word coefficient to the existing TID in the list, at 206. This procedure is repeated, through the logic of 208, 210, until all TIDs for word w have been considered and added to list 196. The program then advances to the next search word, through the logic of 214, 212, and the process is repeated for all TIDs associated with that word. When all of the words in the search vector have been considered (box 244), the program adds the coefficient scores for each TID, and ranks the TIDs by match score, at 216. The final step is to retrieve the class tags of the ranked texts, at 218, by accessing text-ID table 32, to yield a list of ranked class tags.

In FIG. 12, the ranked class tags generated in step 218 in FIG. 11 are shown at 240. The program now accesses class-ID group table 36 to retrieve the corresponding group member information for each of the ranked tags, at 242. That is, for each ranked TID in table 36, the program extracts all of the MIDs and associated information at 242, and culls this list, at 244, to preserve only those MIDs whose group-member data matches the user-specified locale(s), as discussed with respect to FIG. 10.

Typically, the program is set to retrieve at least N group-member names and associated data in response to a user search, where N may be selected to be as few as 1 or as many as 10 or more. If N names are found, these are ranked, e.g., by number of TIDs, and displayed along with pertinent group-member information, as shown in FIG. 10, and indicated at 248 in FIG. 12.

If fewer than N names are found, either because the patent-class tags identified in the search are not associated with a sufficient number of group-member names, or because the group-member locale constraints are too restrictive, the user may expand, at 250, and as discussed above with respect to FIG. 10, either the geographic range or patent-class range of the search. For expansion of geographic range, the program finds the next-proximate locale, at 252, from locale table 40, and repeats step 244, as indicated, where this step now functions to include matching-tag group members with a wider range of geographic identifiers, e.g., county names.

For expansion of the patent-class range, the program accesses tag co-occurrence 38 to identify for each “direct” tag from the user query, at 254, an “indirect” tag having the highest co-occurrence value with respect to the direct tag. The indirect tags are then processed through the steps beginning at 242 in FIG. 12, to identify additional group members who are linked to one or more of the indirect tags. If, at step 246, the total number of group members identified in the search is still fewer than N, the procedure is repeated for the tags having the next-highest co-occurrence values with respect to the direct tags, and so forth, until N names can be displayed to the user.

From the forgoing, it will be appreciated how various objects and features of the invention are met. The method allows a prospective inventors or clients to identify a patent professional with a selected expertise, based on that professional's own patent work, as proof of professional competence. The method also allows patent professionals to directly market themselves and their expertise to prospective clients on a website in a neutral, unbiased forum. Thus, in one preferred embodiment, the search is hosted on a neutral website, such as a website that supports other types of legal and/or technical searching, to allow users to identify qualified patent professionals without having to first access institution or organization websites that are designed in part to promote their own professionals.

While the invention has been described with respect to particular embodiments and applications, it will be appreciated that various changes and modification may be made without departing from the spirit of the invention.

It is claimed:

1. A computer-assisted method for identifying, from among a group of patent practitioners in a given locale, one or more practitioners having technical expertise related to a given invention or technology area, comprising
(a) processing a user-input query composed of word, and optionally, word-group terms that describe or are descriptive of the given invention or technology area,
(b) accessing a database containing a word index of texts of patent abstracts or patent claims or patent classification definitions, to identify one or more texts having high term matches with the user-input query,
(c) accessing a database containing texts linked to patent-class tags linked to the texts, to identify one or more one or more patent-class tags linked to the texts identified in step (b),
(d) accessing a database containing patent-class tags linked to the names and locales of patent practitioners who have prepared patents to which such patent-class tags have been assigned, to identify one or more patent practitioners in a given locale associated with the patent-class tags identified in step (c) and
(e) presenting the patent practitioners identified in step (d) to the user.

2. The method of claim 1, wherein said processing in step (a) includes constructing a search vector composed of non-generic words, and optionally, word-group terms, and term-value coefficients assigned to each term, and said accessing step (b) is effective to identify texts having the top match score with the search vector.

3. The method of claim 1, wherein the databases accessed in each of steps (b)-(d) are database tables in a relational database.

4. The method of claim 1, wherein the database accessed in step (b) includes a word index of abstracts from patents, and the database accessed in step (c) includes a text-ID table linking the abstracts to patent-class number tags associated with patents from which the abstracts are taken.

5. The method of claim 1, wherein the database accessed in step (b) includes a word index of patent-class definitions, and the database accessed in step (c) includes a text-ID table linking the patent-class definitions to associated patent-class number tags.

6. The method of claim 1, wherein said database accessed in step (c) includes a matrix whose matrix values represent, for each pair of patent-class tags, a co-occurrence value related to the document co-occurrence of the two tags of the pair in the patents from which the tags were taken, and step (c) includes accessing the database to identify one or more one or more tags linked directly to the text(s) identified in step (b), or linked indirectly to the text(s) identified in (b) through an above-threshold co-occurrence value to a tag directly linked to such text(s).

7. The method of claim 6, wherein the user can adjust the co-occurrence value applied by the method in step (d).

8. The method of claim 1, wherein said database accessed in step (d) includes a locale database in which specified locales are zip codes or counties that are linked to proximate zip codes or counties, and step (d) includes accessing the database to identify one or more patent practitioners linked to a specified locale or linked to locale that is proximate to the specific locale.

9. The method of claim 6, wherein the user can adjust the degree of locale proximity applied by the method in step (d).

10. The method of claim 1, wherein said step (e) includes presenting, with each patent practitioners identified in step (d), a link to that patent practitioner's website.

11. For use in identifying, among a group of patent practitioners in a given loocale, one or more practitioners having technical expertise related to a given invention or technology, machine-readable code which is operable on a computer to execute machine-readable instructions for performing the steps comprising
(a) processing a user-input query composed of word, and optionally, word-group terms that are descriptive of the given invention,
(b) accessing a database containing a word index of texts of patent abstracts or patent claims or patent classification definitions, to identify one or more texts having high term matches with the user-input query,
(c) accessing a database containing patent-class tags linked to the texts, to identify one or more one or more patent-class tags linked to the texts identified in step (b),
(d) accessing a database containing the names and locales of patent practitioners linked to patent-class tags that have been assigned to patents prepared by such patent practitioners, to identify one or more patent practitioners in a given locale associated with the patent-class tags identified in step (c) and
(e) presenting the patent practitioners identified in step (d) to the user.

12. The machine-readable code of claim 11, wherein the databases accessed are part of a single relational database.

13. A relational database for use in identifying, among a group of patent practitioners, one or more practitioners having expertise related to a given invention or technology, comprising database tables containing:
(i) a word index of texts of patent abstracts or claims or patent-class definitions taken from a library of patents or from a dictionary of patent classes, respectively,
(ii) citation tags linked to the texts, where the tags represent patent-class tags assigned to said texts, and
(iii) group-member identifiers linked to patent-class tags, through patent-class tags taken from patents prepared by members of the group of practitioners.

14. The database of claim 13, which includes a matrix whose matrix values represent, for each pair of patent-class tags, a co-occurrence value related to the document co-occurrence of the two tags of the pair in the patents from which the tags were taken.
